(19) United States
(12) Patent Application Publication
(10) Pub. No.: US 2015/0020671 A1
(43) Pub. Date: Jan. 22, 2015

(54) Rotary Oscillation Cutting Tool for a Machine Tool

(71) Applicant: Robert Bosch GmbH, Stuttgart (DE)

(72) Inventor: Tanja Meindorfer, Zuchwil (CH)

(21) Appl. No.: 14/375,177

(22) PCT Filed: Jan. 3, 2013
(86) PCT No.: PCT/EP2013/050035

§ 371 Date: Jul. 29, 2014

(30) Foreign Application Priority Data
Feb. 2, 2012 (DE) 10 2012 201 667.8

(51) Int. Cl. B23D 61/00

(52) U.S. Cl. CPC B23D 61/006
USPC 83/697

(57) ABSTRACT

A rotary oscillation cutting tool comprises a saw blade body defining a working edge with, at least in sections, a wave profile. The wave profile has at least one half wave raising orthogonally with respect to a saw blade body plane.

The invention relates to a rotary oscillation cutting tool, in particular to a rotary oscillation saw blade for a machine tool, in particular for a powered hand tool, according to the preamble of claim 1.

### PRIOR ART

EP 1 263 333 B1 discloses a plunge-cut saw blade for a machine tool, which plunge-cut saw blade executes an oscillating rotational movement during operation. The plunge-cut saw blade is provided with an approximately rectangular saw blade body which is connected to a holding section via which the connection to the tool shaft is produced. On the side opposite the holding section, the saw blade body has a cutting edge which is provided with cutting teeth and is bent convexly outward.

In addition, it is known to set the teeth such that the lateral tooth regions protrude over the saw blade body side surfaces, and a clearance cut is produced during the machining of the work piece, said clearance cut ensuring better heat dissipation and chip removal.

### DISCLOSURE OF THE INVENTION

The invention is based on the object of designing a rotary oscillation cutting tool with simple structural measures such that, with good heat dissipation and chip removal, even relatively wide grooves can be produced with little outlay.

This object is achieved according to the invention by the features of claim 1. The dependent claims indicate expedient developments.

The invention relates to a rotary oscillation cutting tool in the form of a plunge-cut-type cutting tool, in particular a plunge-cut saw blade, which is usable in machine tools, in particular in hand-guided machine tools, and executes a rotary oscillation movement during operation. The plunge-cut-type cutting tool has a saw blade body which is in the shape of a segment of a circle or is at least approximately rectangular and the side edge of which forms a working edge. A working edge here is understood as meaning, in particular, a cutting edge—preferably a cutting edge provided with cutting elements, a saw edge—preferably a saw edge provided with saw teeth, and/or an abrasive edge—preferably an abrasive edge provided with abrasive elements, such as, for example, grinding elements. The working edge is preferably provided with a cutting coating which has hard cutting particles made of metal, ceramic or another material. In this case, the working edge preferably does not have any cutting teeth. However, embodiments in which, in addition to the cutting coating, the working edge has cutting teeth, at least in sections, may also be advantageous.

In an alternative embodiment, the working edge is provided with cutting teeth. A cutting coating having cutting particles can then be omitted. In an advantageous manner, however, a cutting coating can also be provided, at least in sections, on the working edge.

The working edge of the rotary oscillation cutting tool has a wave profile with at least one half wave which rises orthogonally with respect to the saw blade body plane. This firstly ensures a high clearance cut which comes about by means of the lateral excess length between the side of the working edge and the saw blade body side surface, which promotes the heat dissipation and the chip removal. Secondly, the working edge has a relatively large width—as seen orthogonally with respect to the saw blade body plane, which makes it easier to produce wide grooves.

The working edge has at least one half wave, wherein the working edge can optionally consist of a plurality of half waves or waves, which results in a cutting effect, in particular sawing effect, during a rotary oscillation movement, in which the working edge is moved along the longitudinal direction thereof. A great cutting performance is therefore made possible even if cutting teeth are omitted.

The wave height of the wave profile along the working edge is, for example, 3 mm to 8 mm, based on the maximum elongation orthogonally with respect to the saw blade body plane. If the working edge is provided with a cutting coating having cutting particles, the maximum elongation orthogonally with respect to the saw blade body plane is, for example, 4 mm to 11 mm.

In principle, various wave profiles are suitable. For example, an at least approximately sinusoidal wave profile with a continuous transition from one wave trough to the following wave crest and onto the following wave trough, etc., is possible. Also suitable are polygonal or angular wave profiles, in particular to the effect that the wave profile is composed of a polygonal progression in cross section, and/or the wave profile is provided with edges which run parallel to the saw blade body plane and cut the working edge orthogonally. For example, the wave profile may be of stepped design such that the wave profile is composed of half-open rectangles in cross section. Furthermore, it is possible either for waves following one another to be formed identically or to be able to be formed differently. For example, waves or half waves following one another may have a changing amplitude and/or length. Furthermore, it is possible to superimpose waves of different amplitude and/or length, thus resulting in complex wave shapes.

In yet another expedient embodiment, it is provided that slits which extend parallel to the saw blade body plane and orthogonally with respect to the working edge are introduced into the wave profile. The effect achieved by the formation of the slits is a working edge structure resembling teeth.

According to yet another expedient embodiment, a reinforcing element which expediently likewise has a wave shape or is designed in a manner corresponding to the wave shape of the working edge is placed onto the working edge. The reinforcing profile firstly ensures improved stability and strength of the working edge and, secondly, the width of the working edge is increased, and therefore wide grooves can be produced in a work piece. The cutting profile is optionally provided with the cutting coating, having cutting particles.

According to another expedient embodiment, two oppositely phased wave profiles are placed onto each other in the region of the working edge. In this embodiment, the working edge is formed mirror-symmetrically with respect to a central plane of the saw blade body, with each wave crest being assigned a wave crest which is arranged mirror-symmetrically and rises to the opposite side. Constructionally, this embodiment can be produced, for example, by two interconnected, undulating working edge profiles which are arranged mirror-symmetrically and, for example, are soldered or welded to each other. This wave profile is likewise distinguished by high strength.

According to another expedient embodiment, it is provided that the end side of the working edge is of curved or arcuate design, wherein the curvature lies in the saw blade body plane. In this context, both concave and convex embodiments are suitable, with the corner regions being furthest apart on the outside in the case of a concave working edge and the central region between the corner regions projecting the least amount outward in the case of a concave working edge, whereas, in the case of a convex embodiment, the central bulge extends the furthest outward and is at the greatest distance from the clamping end.

Further advantages and expedient embodiments can be gathered from the further claims, the description of the figures and the drawings, in which:

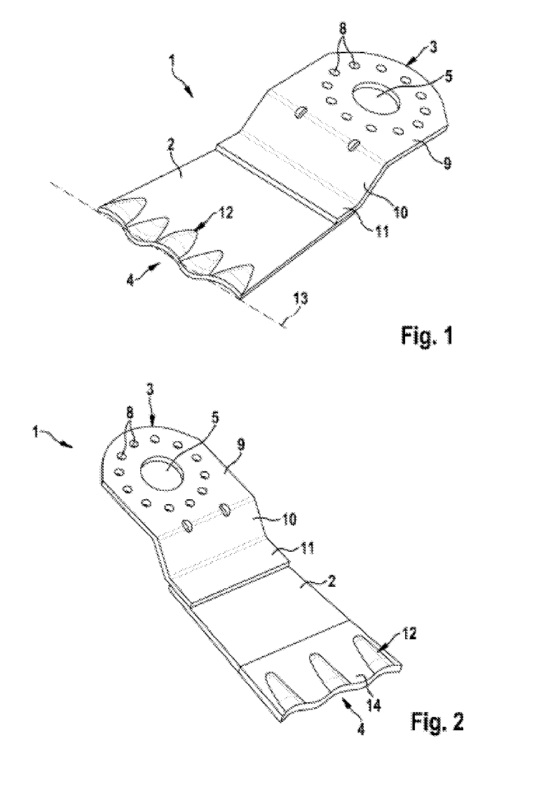

FIG. 1 shows a perspective view of a plunge-cut saw blade with a wavy working edge,

FIG. 2 shows a plunge-cut saw blade with a wavy working edge which is provided with a cutting coating having cutting particles,

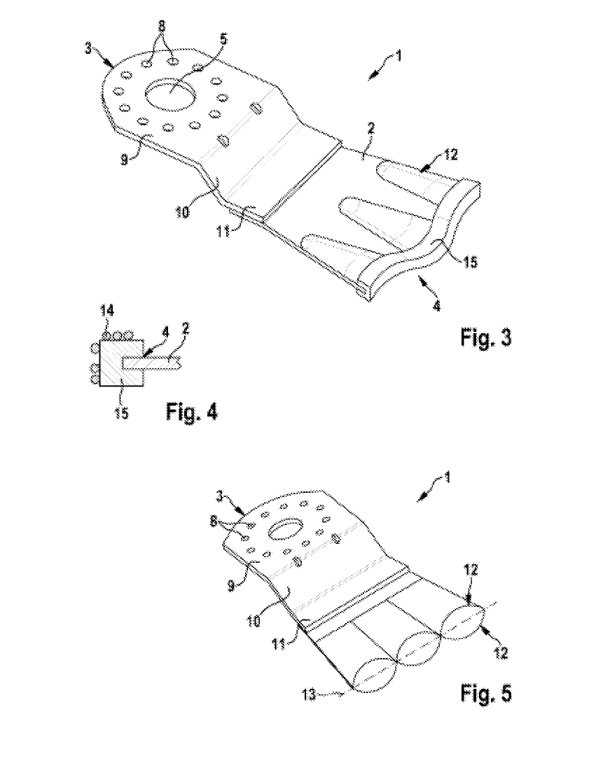

FIG. 3 shows a further plunge-cut saw blade with a reinforcing element placed onto the working edge,

FIG. 4 shows the working edge with the reinforcing element from FIG. 3 in section,

FIG. 5 shows a further exemplary embodiment in which the working edge has two oppositely phased wave profiles which are placed onto each other,

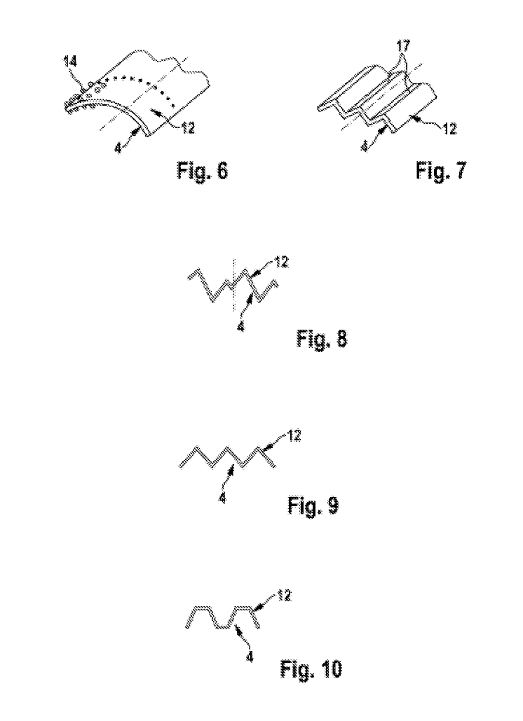

FIGS. 6 to 13 show exemplary embodiments with different wave profiles.

In the figures, identical components are provided with the same reference numbers.

FIG. 1 shows a plunge-cut saw blade 1 for a powered hand tool with a rotary oscillation drive as an example of a rotary oscillation cutting tool according to the invention. The plunge-cut saw blade 1 comprises a saw blade body 2 which is approximately rectangular or is of slightly trapezoidal design, and a holding part 3 which is connected to the saw blade 2 which is formed offset with respect to the saw blade body 2. On the side remote from the holding part 3, the saw blade body 2 is provided with a working edge 4. The working edge 4 here is preferably designed as a cutting edge, saw edge and/or abrasive edge. The holding part 3 comprises a shaft receiving section 9 with a fastening receptacle 5 for receiving the tool shaft of the machine tool. The fastening to the tool shaft takes place by means of latching openings 8 which are introduced into the shaft receiving section annularly about the central fastening recess 5.

The holding part 3 is furthermore provided with a transition section 10 of curved design and with a connecting section 11 via which the holding part 3 is connected to the saw blade body 2. The saw blade body 2 and the holding part 3 are formed separately from each other and are fixedly connected to each other. The shaft receiving section 9 and the connecting section 11 of the holding part 3 lie offset parallel to each other because of the obliquely running transition section 10.

The working edge 4, which does not have any cutting teeth, is provided with a wave profile 12 which, along the working edge, has a plurality of waves with wave troughs and wave crests which extend orthogonally with respect to the saw blade body plane 13 of the saw blade body 2. One wave crest of the wave profile 12 extends in each case on the near side of the saw blade body plane 13 and one wave trough extends in each case on the far side thereof. The maximum elongation between a wave crest and a wave trough is, for example, 3 mm to 8 mm, based on the direction orthogonally with respect to the saw blade body plane. In the case of a cutting coating which has cutting particles made from hard metal, ceramic or another material, the total elongation can be 4 mm to 11 mm. The wave crests and wave troughs extending transversely with respect to the saw blade body plane protrude in each case over the assigned saw blade body side surface in the lateral direction, i.e. orthogonally with respect to the saw blade body plane, thus resulting in a relatively large clearance cut which promotes the heat dissipation and chip removal and, in addition, makes a relatively large groove width possible during the machining of the work piece.

In the exemplary embodiment according to FIG. 2, the working edge 4 of the plunge-cut saw blade 1 likewise has an undulating profile with a plurality of waves having wave troughs and wave crests which extend orthogonally with respect to the saw blade body plane and protrude over the respective saw blade body side surface. In addition, the wave profile 12 is provided with a cutting coating 14 which has a multiplicity of small, hard cutting particles which are composed of hard metal, ceramic or another material. The cutting coating 14 preferably extends on the two side surfaces of the wave profile, on the end side and on the two narrow sides. The entire wave profile 12 on the saw blade body 2 is expediently provided with the cutting coating 14.

In the exemplary embodiment according to FIG. 3, a reinforcing element 15 is placed onto the working edge 4 having the wave profile 12, said reinforcing element, as can also be gathered from the sectional illustration according to FIG. 4, engages in a U-shaped manner in cross section around the free end side of the working edge 4. The reinforcing element 15, which improves the strength and rigidity of the working edge, follows the wave shape of the wave profile 12. As can be gathered from the sectional illustration according to FIG. 4, the reinforcing element 15 can be provided with a cutting coating 14 having cutting particles.

As can be gathered by way of indication from the perspective illustration of the plunge-cut saw blade according to FIG. 3, the end side of the working edge 4 can be of convexly curved design, thus resulting in a central bulge on the working edge, which bulge extends further outward than the border regions or corners of the working edge. The curvature of the working edge is superimposed on the wave profile 12. In principle, a concave curvature is also possible instead of a convex curvature.

In the exemplary embodiment according to FIG. 5, the plunge-cut saw blade 1 is provided, in the region of the working edge 4, with two oppositely phased wave profiles 12 which are arranged in a mirror-inverted manner with respect to the saw blade body plane 13. Therefore, opposite each wave crest which rises over a saw blade body side surface, there is a corresponding wave crest which rises over the opposite saw blade body side surface.

FIGS. 6 to 13 illustrate exemplary embodiments with different wave profiles 12. According to FIG. 6, the wave profile 12 on the working edge 4 only comprises a single half wave which is optionally covered with a cutting coating 14. According to FIG. 7, the wave profile 12 has a polygon-like cross section with edges 17 which extend parallel to the saw blade body plane and run orthogonally with respect to the working edge 4. The edges 17 form the corners into polygon-like cross section which is approximate to a wave shape. According to FIG. 8, the wave profile 8 on the working edge 4 is provided with a complex cross section in which various wave shapes of differing length and amplitude are superimposed. In FIG. 9, in a similar manner as in the exemplary embodiment according to FIG. 7, the wave profile 12 is provided with a polygon-like cross section, wherein wave progressions following one another may differ in respect of the length thereof and optionally the amplitude thereof. According to FIG. 10, the wave shape 10 has an angular cross-sectional profile, in which individual half waves are of trapezoidal design.

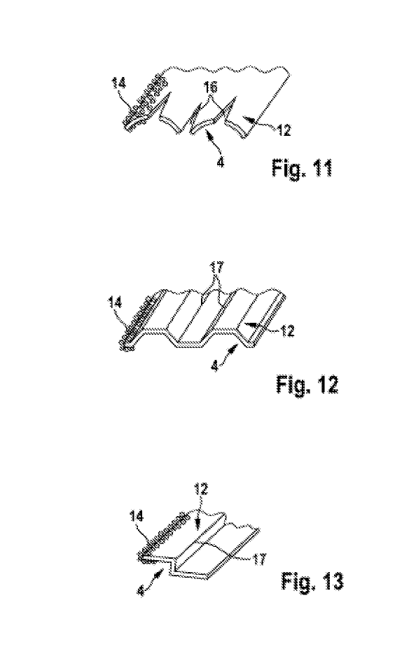

In the exemplary embodiment according to FIG. 11, slits 16 which run parallel to the saw blade body plane and extend orthogonally with respect to the working edge are introduced into the wave profile 12. Owing to the slits 16, the working edge 4 has a tooth-shaped wave profile.

The wave profile according to FIG. 12 corresponds to that according to FIG. 10 with a trapezoidal wave cross section and longitudinal edges 17 in the region of the corners of the profile.

In the exemplary embodiment according to FIG. 13, the wave profile is provided with steps which are separated from one another in each case by longitudinal edges 17.

1. A rotary oscillation cutting tool comprising:
a saw blade body defining a working edge with, at least in sections, a wave profile,
wherein the wave profile has at least one half wave raising orthogonally with respect to a saw blade body plane.

2. The cutting tool as claimed in claim 1, wherein:
the wave profile has edges running parallel to the saw blade body plane and extending orthogonally with respect to the working edge.

3. The cutting tool as claimed in claim 2, wherein the wave profile has steps.

4. The cutting tool as claimed in claim 2, wherein the wave profile has a cross section with a polygonal progression.

5. The cutting tool as claimed in claim 1, wherein the wave profile has slits running parallel to the saw blade body plane and extending orthogonally with respect to the working edge.

6. The cutting tool as claimed in claim 1, wherein:
a wave height of the wave profile between a wave trough and a wave crest is 4 mm to 6 mm.

7. The cutting tool as claimed in claim 1, wherein the working edge includes a coating having cutting particles.

8. The cutting tool as claimed in claim 1, further comprising a reinforcing element positioned on the working edge.

9. The cutting tool as claimed in claim 1, wherein the wave profile is defined by two oppositely phased wave profiles placed onto each other at the working edge.

10. The cutting tool as claimed in claim 1, wherein an end side of the working edge is curved.

11. A machine tool comprising:
a rotary oscillation cutting tool, including:
a saw blade body defining a working edge with, at least in sections, a wave profile,
wherein the wave profile has at least one half wave raising orthogonally with respect to a saw blade body plane.
